(19) United States
(12) Patent Application Publication
(10) Pub. No.: US 2011/0076397 A1
(43) Pub. Date: Mar. 31, 2011

(54) Pipe lining method and apparatus

(76) Inventor: Edwin L. Rauch, Fulton, NY (US)

(21) Appl. No.: 12/924,581

(22) Filed: Sep. 29, 2010

Related U.S. Application Data
(60) Provisional application No. 61/277,806, filed on Sep. 30, 2009.

(51) Int. Cl. B05D 7/22; B05C 7/08

(52) U.S. Cl. 427/230; 118/254

(57) ABSTRACT

An exemplary embodiment provides a form for providing a lining in a pipe. The form includes a body having a leading part and a trailing part, a hole in a leading side of the leading part and a channel in the body communicating with the hole. The body has a diameter at the leading part that is similar to the inner diameter of the pipe to be lined and greater than the diameter at the trailing part. The channel has at least one peripheral opening positioned rearwardly of the leading part of the form at a position to discharge lining material from the channel around the trailing part of the form and onto the interior surface of the pipe. The form is preferably provided with an attachment on the leading side for a tube supplying flowable settable lining material to and through the hole. Another embodiment relates to a method of producing a lining in a pipe which comprises supplying flowable settable lining material to the form while pulling the form through the pipe.

### CROSS-REFERENCE TO RELATED APPLICATIONS

This application claims the priority right of co-pending U.S. provisional application Ser. No. 61/277,806 filed Sep. 30, 2009 by applicants named herein. The disclosure of U.S. provisional application Ser. No. 61/277,806 is specifically incorporated herein by this reference.

### BACKGROUND OF THE INVENTION

(1) Field of the Invention

This invention relates to a method of and apparatus for lining pipes. More particularly, the invention relates to such a method and apparatus for lining pipes with settable materials, e.g. pastes, aggregates, jells, settable liquids, and the like.

(2) Description of the Related Art

It is often desirable to line pipes made of metal or plastics with a material that is resistant to attack by products conveyed through the pipes and/or that provides heat or electrical insulation, or the like. For example, pipes are often lined with concrete or refractory ceramic products so that they may convey fluids, such as molten metals, caustic liquids, hot gases and the like, that would destroy unlined pipes. Current lining methods employ fixed forms inserted into the pipes so that concrete or other material that can be chemically or thermally set may be introduced between the interior of the pipes and the forms. After the material has set to produce a solid lining, the forms must be removed. This is a time-consuming operation that is made more difficult if the pipe has a complex geometry. It would therefore be desirable to provide a more simple, rapid and adaptable way of providing pipes with linings of this kind.

U.S. Pat. No. 5,779,948 which issued to Perkins et al. on Jul. 14, 1998 discloses a method of lining a pipeline using a constant extrusion pressure. FIG. 4 of the patent shows a pipe lining form being pulled towards the right hand side of the drawing by a cable. Ahead of the form is a slug of lining material, mortar in this case, further confined at its leading edge by a squeegee. Spring guides serve to centre the form in the pipe. The mortar is pre-added ahead of the form, and the squeegee is not attached to the form and functions only to contain the variable length slug of mortar as the form moves along.

U.S. Pat. No. 4,764,237 which issued to Shishkin et al. on Aug. 16, 1988 discloses a method of and apparatus for coating the internal surface of a pipeline with a cement-sand mortar. In FIG. 6 of the patent, mortar is added ahead of a form and the form is pulled by cable. The apparatus includes centering guides for the form. No additional squeegee is shown (unlike the patent referred to above), but the apparatus is otherwise similar to that of U.S. Pat. No. 5,779,948.

U.S. Pat. No. 5,246,641 which issued to Perkins et al. on Sep. 21, 1993 also refers to a method of lining a pipe with cement mortar. The prior art arrangement shown in FIG. 1 of the patent feeds a lining material via a hose attached to a lining machine, that is followed by a cone shaped “drag trowel”. However, the actual liner application is via a centrifugal applicator that spins the lining material into place.

### BRIEF SUMMARY OF THE INVENTION

An exemplary embodiment of the invention provides a form for producing a lining in a pipe. The form comprises a body having a leading part and a trailing part, a hole in a leading side of the leading part and a channel in the body communicating with the hole. The body has a diameter at the leading part that is greater than the diameter of the trailing part. The channel has at least one peripheral opening situated rearwardly of the leading part of the form at a position to discharge lining material from the channel around the trailing part of the form, and a supply tube, or an attachment on the leading side for a supply tube, for supplying flowable settable lining material to and through the hole.

Preferably, the leading side of the leading part has an attachment for an elongated pulling element, which may be the same as the attachment for the supply tube when the supply tube is to be used to pull the form through a tube.

The leading part of the form preferably has a concave trailing surface and the trailing part has a convex leading surface. These surfaces are preferably both frusto-conical and are preferably separated by a gap forming the channel in the body, and are preferably partially nested together. The peripheral opening for the lining material may then be formed by the periphery of the gap between the two parts. The leading part and said trailing part may be joined together by one or more rigid struts.

The leading part of the form preferably has a flexible edge region adjacent a radially outer periphery thereof. This edge region contacts the inner surface of a pipe to be coated. The trailing part of the form preferably has a skirt extending rearwardly from a leading surface of this part. This skirt contacts the lining material, shapes it into a layer and forces it against the inner surface of the pipe. The skirt preferably has a region adjacent to the leading surface that slopes away from a central axis of the form in the rearward direction, followed by a region that slopes towards the central axis in the rearward direction. This causes the skirt to compress the layer of lining material as it is applied, and then allows the form to break contact with the lining layer without disturbing the newly formed surface of the layer.

The trailing part of the form preferably has a hollow interior and houses apparatus for modifying lining material. This apparatus may include a manifold for delivering a liquid to a plurality of holes extending from the hollow interior to an exterior of the trailing part, a vibrator for compacting lining material as it is applied to the interior of a pipe, and a heater for heating lining material as it is applied.

The form preferably has guides extending radially from the trailing part positioned to cause the form to be centered within a pipe having an inner diameter corresponding to the diameter of the leading part.

Another exemplary embodiment provides a form for lining an interior of a pipe, comprising a material feeder part and a material applicator part axially aligned and joined together with a gap there-between. The material feeder part has an outer periphery, a leading wall extending to the outer periphery, an opening in the leading wall communicating with the gap. The material feeder part also has a trailing wall adjacent the gap extending from the opening to the outer periphery of the material feeder part. The material applicator part comprises a body having a leading wall terminating at a peripheral edge and a peripheral skirt extending axially of the body rearwardly from the peripheral edge of the leading wall, the leading wall sloping rearwardly and outwardly from a central region to the peripheral edge. The periphery of the material feeder part extends by a greater radial distance than the peripheral edge and peripheral skirt of the material applicator part.

Another exemplary embodiment provides a method of lining a pipe. The method comprises supplying a flowable settable lining material to a leading end of a lining form through a tube passing through the pipe, and pulling the form through the tube by pulling the tube as lining material is supplied thereto. Preferably, the form has the elements as described above.

As noted above, in some exemplary embodiments, the tube used to supply the form with lining material is used to pull the form through the pipe during a lining operation. This is preferred in many cases because it simplifies the design of the form. However, it is alternatively possible to use a separate element, e.g. a string, rope or cable, to pull the form through the pipe so that no tension is exerted onto the tube supplying the lining material. However, the attachment of such an element should preferably be such that the form is pulled through the pipe without causing any tendency of the form to twist or slew under pulling forces imposed by such an element. The element should therefore preferably be attached at several points arranged symmetrically around the central longitudinal axis of the form. The elongated pulling element, whether the supply tube or a separate element, may be wound onto the drum of a winch turned by an engine at a speed appropriate for the lining operation, i.e. a speed that allows the lining to be formed without defects and that allows the lining material to harden, cure or jell sufficiently to hold its shape before losing contact with the form. The speed or pressure at which the lining material is supplied to the form depends on the properties of the lining material. The lining materials are often of high viscosity, so pumps of large capacity capable of producing high pressures (e.g. typical cement pumps) may be required in many cases. If the supply tube is used to pull the form through the pipe by being wound on a drum, it is preferable to avoid forming multiple overlying wraps on the drum to avoid the possibility of constricting the supply tube.

Lined pipes produced by the exemplary embodiments may be used for many and varied applications. For example, without limitation, metal pipes may be provided with ceramic linings so that molten metal or caustic products can be pumped or siphoned therethrough without damage and/or without undue loss of heat. Moreover, furnace exhaust stacks and hot combustion air ducting may be provided with ceramic linings, again to avoid corrosion and to reduce heat losses. Pipes with non-ceramic linings may also be produced, e.g. pneumatic conveying and slurry pipes lined with a rubber compound or a reinforced polymer coating.

It should be noted that terms such as “front”, “leading”, “rear”, etc. as used herein to describe parts of the form refer to the direction in which the form is moved through a pipe during a pipe lining operation. That is to say, a leading or front part or surface is one that leads as the form is pulled through a pipe, etc.

### BRIEF DESCRIPTION OF THE SEVERAL VIEWS OF THE DRAWINGS

Exemplary embodiments of the invention are described in detail in the following with reference to the accompanying drawings, in which:

FIG. 1 is perspective view of an exemplary embodiment of a pipe-lining form attached to a lining material supply tube;

FIG. 2 is perspective view of a pipe-lining form of the kind shown in FIG. 1 (but with the supply tube omitted) with parts shown in cross-section to reveal interior details;

FIG. 3 is a cross-section of the material applicator part of the form of FIG. 2 showing the angles of various circumferential regions thereof;

FIG. 4 is a vertical cross-section of a pipe showing a lining operation in progress employing a form and material supply tube of the kind shown in FIG. 1;

FIG. 5 is a cross-section of a form and supply tube in isolation showing the manner of attachment of these two parts; and

FIG. 6 is a cross-section showing an alternative exemplary embodiment of the invention.

### DETAILED DESCRIPTION OF THE EXEMPLARY EMBODIMENTS

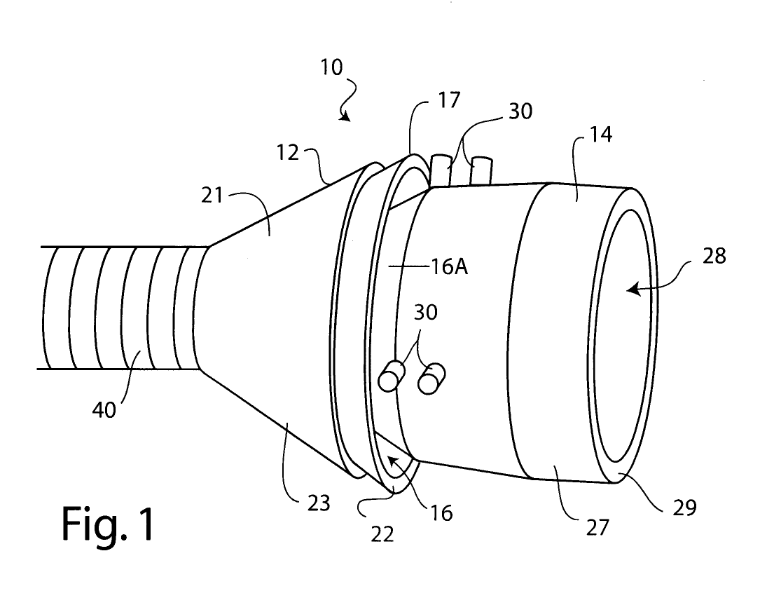

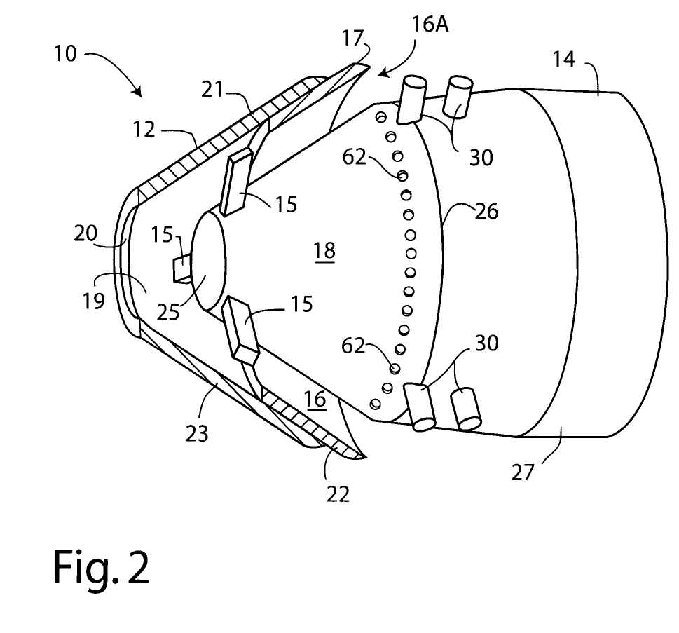

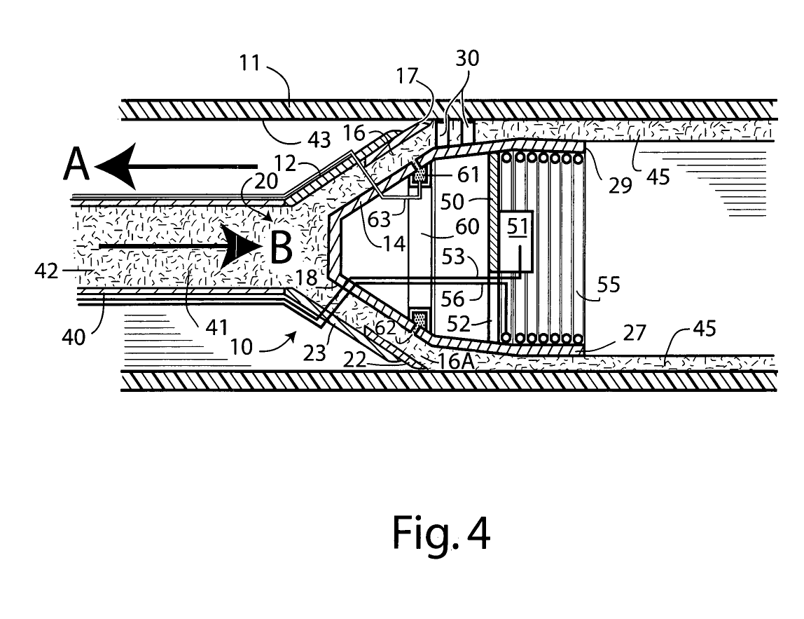

A first exemplary embodiment of the present invention is shown in FIGS. 1 to 5 of the accompanying drawings. The embodiment employs a slidable form 10 for producing a lining in a pipe. The form 10 is shown attached to an elongated reinforced lining material supply tube 40 described in more detail later. The form has two main parts, namely a hollow cone-shaped material feeder part 12 forming a leading part of the form 10, and bullet-shaped material applicator part 14 forming a trailing part of the form 10. The form 10 is dimensioned to pass with tight clearance through a pipe 11 to be lined (FIG. 4), at least at the leading part thereof. As best seen from FIG. 2, these two parts are firmly held together in spaced but co-axial relationship to form a unitary body of the lining form 10. The parts are held together by one or more, but preferably three, equally-spaced, rigid struts 15 together forming a so-called “spider” creating a gap 16 between the two form parts 12 and 14 acting as an internal channel for conveying and distributing lining material through the form 10. The gap 16 has an unbroken peripheral opening 16A positioned immediately downstream of the leading part 12 of the form. The struts 15 are integral with or securely adhered to a leading wall 18 of the material applicator part 14 and a rear wall 19 of the material feeder part 12. The struts are long enough that the gap 16 between the two parts, which forms a channel in the form body, is wide enough for effective material delivery, as will be described later.

The leading material feeder part 12 has a central axial hole 20 in leading surface 21 and is made of two nested hollow frusto-conical elements, i.e. an inner element 22 and an outer element 23, that are nested together without any intervening gap or opening between the overlapping parts thereof. These elements are preferably adhered to each other at the overlapping parts with a suitable adhesive, or are otherwise mutually permanently attached. The outer element 23 is preferably made of a rigid material (e.g. metal, ceramics or dense plastics, wood, etc.) and the inner element 22, which extends to a radially outermost periphery 17 of the leading material feeder part 12, is preferably made of a tough but flexible resilient or elastic material that yields when acted on by a force, e.g. leather or a reinforced elastomer such as urethane rubber. If desired, instead of providing two frusto-conical elements 22 and 23 nested together as shown, the material feeder part may be made of just one frusto-conical element 23 provided with an outer edge made of suitably flexible material or that is itself made entirely of suitable flexible (but still quite stiff) material. In such a case, the element 23 is provided with dimensions equivalent to those of the combined elements 22 and 23 of the illustrated embodiment, i.e. extending to the position of outermost periphery 17.

The leading surface 18 of the trailing bullet-shaped material applicator part 14 of the form 10 is frusto-conical (conically convex) in shape and it slopes outwardly from a central flat circular leading end 25 to an outer peripheral edge 26. Extending rearwardly from the peripheral edge 26 is a generally (but preferably not exactly) cylindrical skirt 27. The material applicator part 14 has a hollow interior 28 that is open at a rear end wall 29, although in other embodiments the material applicator part may be solid throughout. Also in other embodiments, the leading surface 18 may come to a sharp or rounded point rather than terminating in the flat disc 25 as shown, provided that flow areas are maintained large enough to prevent poor distribution of lining material and to avoid high pressure drops within the form.

The material applicator part 14 of the form has preferably three pairs of radially projecting rigid guides 30 preferably arranged at equal spacings (i.e. separated by120°) around the circumference of the applicator part. The positions of these guides may be axially aligned with the struts 15 of the spider, or may be offset angularly relative to those struts. The guides 30 extend radially to a distance from the center of the form 10 approximately the same as that of the periphery 17 of the material feeder part 14, and are used to center the form within a pipe, as will be described later. The material applicator part 14, including guides 30, is preferably made of an unyielding material such as metal, ceramics, dense plastics or wood, and may have an outer coating (not shown) that reduces friction with and adhesion to the coating material or, in the case of guides 30, the pipe 11.

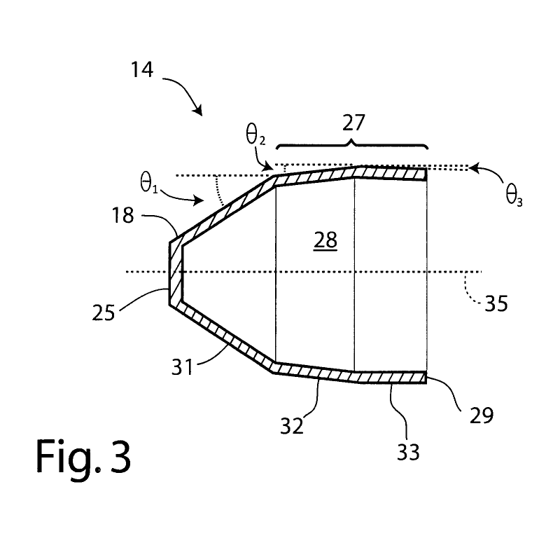

As shown in FIG. 3, the material applicator part 14 of the form has an outer surface provided with three circumferential regions 31, 32 and 33. The first region 31 is formed by the leading surface 18 and, as noted above, this is frusto-conical in shape. This region preferably has an outward directed surface angle Θ₁ (angle between surface and a central axis 35 of the form) that is similar or identical to the surface angle of the adjacent rear surface 19 of the material feeder part 12 (FIG. 2). The gap 16 is thereby of the same width throughout. This surface angle Θ₁ may, for example, be in the range of 5 to 90°, more preferably 30 to 60°, relative to the central axis 35 of the form. Next downstream, and forming part of the peripheral skirt 27, is a second circumferential region 32 that is preferably also frusto-conical, extending radially outwardly and rearwardly and having an outward surface angle Θ₂ that is smaller than Θ₁, preferably in the range of 0 to 80°, more preferably 0 to 15°. A final circumferential region 33 of the material applicator part 14, which also forms part of the skirt 27, may be exactly cylindrical, but is more preferably frusto-conical with a reverse taper, i.e. extending slightly towards the central axis 35 with increasing distance from the leading end 25. This is represented in FIG. 3 by surface angle Θ₃ which may be in a range of 0 to 10°, more preferably 0 to 5°.

As shown in FIG. 4, the applicator part 14 is provided in this embodiment with an internal bulkhead 50 supporting an electrical vibrator 51. The bulkhead has a slot 52 that allows electrical wiring 53 to pass from the vibrator forwardly through the material applicator part 14, through a hole in its leading surface 18, across the gap 16, through a hole in the wall of the material feeder part 12, and then along the outside of the supply tube 40. This allows the vibrator to be supplied with electrical current from a source located outside the pipe 11. The position where the wiring passes through the gap 16 may be chosen to allow the wiring to pass immediately to the rear of one of the struts 15 to shelter the wiring from the lining material moving through the form, or in any other position. The holes provided for the wiring in the leading and trailing parts of the form should be small and preferably sealed to prevent penetration of lining material through these holes. The interior 28 of the applicator part 14 is also provided with electrical heating coils 55 that heat the applied material by conduction through the skirt 27. The coils are supplied with electricity via wiring 56 in the same way as the vibrator 51.

The interior of the applicator part 14 is further provided with a channel member 60 fixed to the inner wall of the applicator part that acts as a manifold to supply a liquid curing agent 61 to a series of small holes 62 (see FIG. 2) spaced around the periphery of the leading surface 18 of this part. The channel member 60 may be supplied with the liquid curing agent 61 under pressure via a small tube 63 that, like the wiring 53 and 56, passes forwardly across the gap 16 and along the exterior of the material supply tube 40.

The leading material feeder part 12 has an outer diameter at periphery 17 that is the same as, or slightly larger than, the internal diameter of pipe 11 to be lined. The trailing material applicator part 14 has a maximum diameter that is less than the internal diameter of the pipe 11 by an amount corresponding to twice the thickness of a lining 45 to be produced.

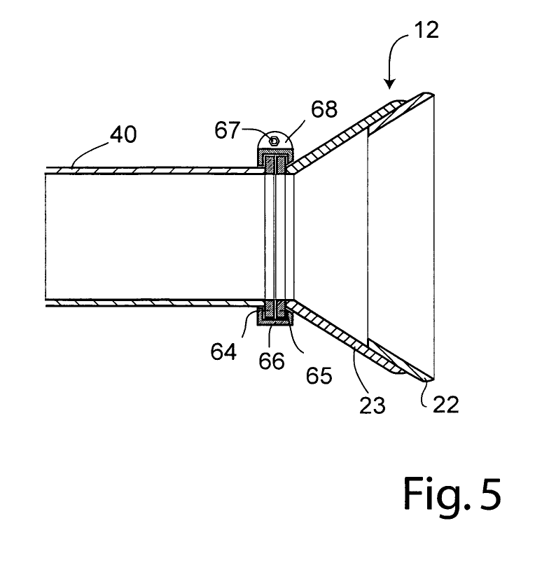

As noted, and as shown in FIG. 1 and FIG. 4, in order to carry out a lining operation, the form 10 is securely joined around its central opening 20 to an elongated reinforced tube 40. The tube may be integral with the form 10, but may alternatively be detachable as shown in FIG. 5. In this figure, the tube 40 is provided with an integral outwardly extending circular metal flange 64 and the form 10 is provided with a corresponding flange 65. These flanges are abutted together and secured by a surrounding split channel-shaped metal collar 66 tightened by a bolt 67 passing through upstanding tabs 68 positioned on each side of the split.

Referring again to FIG. 4, the tube 40 has an interior channel 41 which communicates with the hole 20 and thereby with the gap 16. At the opposite end (not shown), the tube 40 is connected to a supply (not shown) of a flowable settable lining material 42, e.g. paste-like or semi-solid compound such as a fine grained or mixed aggregate cement. The tube 40, either after it is attached to the form 10 or before, is first passed fully through the pipe 11 to be coated employing normal fishing techniques, such as the use of a steel fish or ball and cord used to pull the tube through the pipe. If the form 10 has not already been attached to the tube 40, the form is then attached to the free end of the tube 40 and the supply of lining material is put under pressure (e.g. via a concrete pump or the like, not shown). The tube 40 is then used as an elongated pulling element for the form by being drawn through the pipe 11 in the direction of arrow A by force exerted on the tube 40 outside the pipe, e.g. using a winch drum (not shown) or the like. The speed at which the form is drawn through the pipe is preferably kept as constant as possible. As can be seen from FIG. 4, the lining material is forced through the hole 20, the gap 16, out of the peripheral opening 16A and into contact with an interior surface 43 of the pipe and the exterior surface of the trailing part 14 of the form, thereby creating an annular internal lining 45 for the pipe. The lining may be allowed to set (e.g. by e.g. by curing or jelling) so that the material solidifies to form a robust solid layer.

The narrow leading end of the material applicator part 14 of the form forces the lining material 42, as it enters the form 10 from the tube 40, towards the inner surface 43 of the pipe and this flow of material is also guided by the rear surface 19 of the material feeder part 12. The lining material flows around struts 15, but any gap or cut in the layer of lining material caused by the struts is closed by the pressure applied by the leading surface 18 of the material applicator part 14. The periphery 17 of the inner frusto-conical element 22 is dimensioned to bear with slight pressure against the inner surface 43 of the pipe 11 so that lining material cannot pass around the form in the upstream direction. Since this element is flexible, it yields resiliently if it encounters any uneven contours of, or projections from, the inner surface of the pipe. The pressure of the lining material in the form 10 and/or the elastic properties of the element 22, keep the periphery 17 in contact with the inner surface, even after encountering such surface irregularities.

The guides 30 are also dimensioned to lightly contact the interior surface 43 of the pipe 11 to center the form 10 within the pipe. The lining material must also flow around these guides, but any cut or gap thereby formed in the layer of lining material is closed because of the slight outward taper of the circumferential region 32 of the material applicator part 14 (FIG. 3), which slightly squeezes and compresses the lining layer against the inner surface 43. This action also ensures that the layer of lining material is pressed firmly against the inner surface 43 to assist with conformance and adhesion. Because of the reverse taper of the third circumferential region 33, contact with the fully formed lining 45 is broken in a smooth gradual fashion that prevents tugging and tearing of the layer caused by vacuum generation as the form moves onwards and the lining remains in place. The form 10 is preferably dimensioned to fit precisely within a pipe to be lined, although some degree of play is permitted because of the resilient nature of the element 23. In some embodiments, there may be no need to provide guides 30, e.g. if the thickness of the lining does not have to be constant throughout and a small divergence between the central longitudinal axis of the form and that of the pipe can be tolerated.

If necessary, liquid curing agent 61 may be supplied to the lining material 42 via holes 62 formed in the trailing part 14 as the material flows past these holes. The curing agent is fed to the holes under pressure via channel member 60 and tube 63. The lining material may also be compacted by operating the vibrator 51 that slightly shakes the form 10 as the material is being applied. Also, the material may be heated to help it to solidify and cure by operating the electrical heating coils 55 positioned within the material applicator part 14 of the form 10.

The exemplary embodiments, while able to line pipes of almost any diameter, are most useful when used with pipes having diameters that are generally too small for traditional lining methods, e.g. from about 3 inches to about 3 feet (preferably 6 to 12 inches). The thicknesses of the resulting linings may be, for example, from 0.25 to 12 inches, more preferably 1 to 4 inches, and even more preferably 1 to 1.5 inches. Optimally, the cross-sectional area of the tube 40 is made the same as, or similar to, the circumferential cross-sectional area of gap 16 (and thereby the cross-sectional area of the lining layer 45), as there is then no over- or under-supply of lining material to the form that could result in the production of a linings having regions of reduced or uneven thickness. The pipes lined in this way may be of any length, but lengths of 10 to 50 feet are usual.

While the exemplary embodiments are preferably employed for producing pre-lined lengths of pipe for use in subsequent manufacture of equipment, the embodiments may also be used for lining pipes or pipelines in situ, e.g. for sealing cracked or leaking sections of pipe by the application of an internal lining of sealant material.

As noted above, the lining material may be a kind of concrete, e.g. a mixture of aggregates and binders that set thermally or chemically to produce a rigid layer, or any other ceramic refractory material, or any settable paste or semi-solid material. Shotcrete® is an example of a ceramic lining material that may be employed. This consists of a dispersion of metal oxides (e.g. oxides of silica, alumina, titanium and calcium, among others) in an aqueous liquid. Other examples of lining materials include glass-filled polyester resin used with a hardener supplied as the liquid curing agent, or rubber-filled polyester or epoxy resin, again using a hardener supplied as the liquid curing agent.

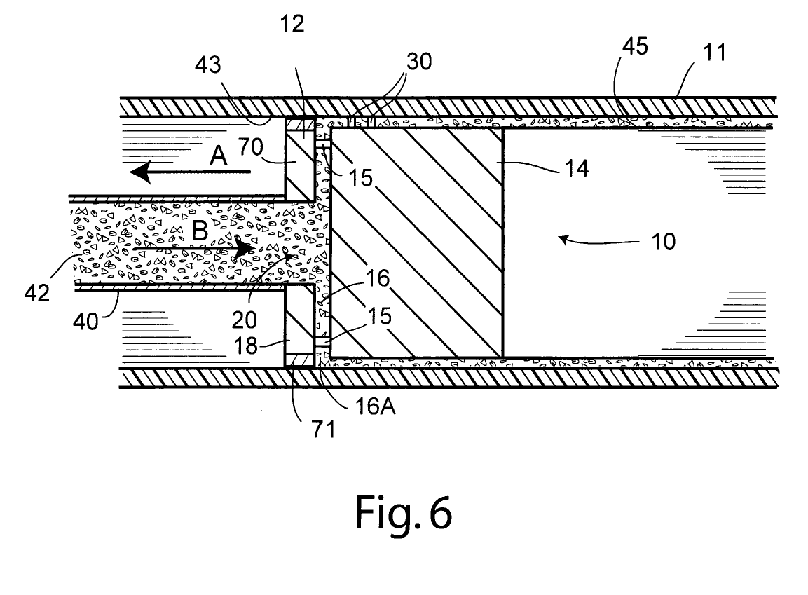

The apparatus shown in FIGS. 1 to 5 is especially useful for the application of a paste-like aggregate such as a concrete mixture. However, if a more fluid lining material is employed, the form may be of a more simple construction, e.g. as shown in FIG. 6. In this alternative exemplary embodiment, the form 10 still consists of two parts, i.e. parts 12 and 14 joined together to form a form a unitary body. These two parts are held together by rigid struts 15 spaced equally around the periphery of the two parts. Preferably there are four such struts 15. The struts hold the two parts 12 and 14 away from each other on opposite sides of a gap 16 forming a distribution channel within the body. The trailing part 14 is of smaller diameter than the leading part 12 to allow space for the formation of the lining 45. This part also has pairs of rigid guides 30 spaced around its periphery (e.g. three such pairs arranged at 120° to each other) to center the body within the pipe 11 to be lined. The trailing part 14 in this embodiment is solid, but may alternatively be made hollow as in the case of the earlier embodiment, if it is desired to provide a manifold for a liquid curing agent, a vibrator and/or heating coils.

In this exemplary embodiment, the leading part 12 of the form 10 is in the shape of a flat plate 70 having a peripheral edge 71 made of a flexible material. A lining material supply tube 40 is attached to the leading surface 18 of the leading part 12 in communication with a central hole 20 that communicates with the gap 16 having a peripheral opening 16A immediately adjacent to the trailing side of the flat plate 70. The form 10 is pulled in the direction of arrow A as lining material 42 is forced under pressure in the direction of arrow B. Since the lining material 42 is quite fluid, it readily flows through the tube 40, into and through the gap 16, to the periphery of the second part 14 of the form, and thereby lines the inner surface 43 of the pipe as in the previous embodiment. Although the material 42 is quite fluid, it preferably contains (or is supplied with) a curing agent or hardener so that it is able to support itself as a lining for the pipe before losing contact with the form 10. The axial length of the trailing part 14 may be varied according to the ability of the lining material to become self-supporting. That is to say, of the lining material sets quickly, the trailing part 14 may be quite short, but if the lining material is slow to set, the trailing part 14 may be made longer to provide support for a longer period of time. In general, the trailing part should be kept as short as possible to reduce friction and to allow the form to follow contours within the pipe without causing undue variations in the thickness of the lining and without becoming jammed.

A variant of this alternative embodiment (not shown) has a single piece body very similar to the form of FIG. 6, except that the peripheral gap 16A is closed by a short peripheral wall extending from the leading part 12 to the trailing part 14. The gap 16 forms a channel in the body that communicates with the exterior via a series of peripheral openings (small holes) extending through the short wall. Thus the peripheral opening 16A of the embodiment of FIG. 6 is replaced by a series of holes in a short wall encircling the gap 16. This embodiment is for use with lining materials sufficiently fluid to pass through the series of small holes and to join up on the other side of the short wall to form a continuous lining for the pipe. Thus, the form 10 is made of one piece having an interior channel corresponding to the gap 16 of the earlier embodiments.

Other design variations and embodiments are possible within the scope of the following claims.

What I claim is:

1. A form for producing a lining in a pipe, comprising
a body having a leading part and a trailing part, a hole in a leading side of the leading part and a channel in the body communicating with the hole, said body having a diameter at said leading part that is greater than a diameter at the trailing part, and said channel having at least one peripheral opening situated rearwardly of the leading part of the form at a position to discharge lining material from said channel around said trailing part of the form, and
a supply tube, or an attachment on said leading side for a supply tube, for supplying flowable settable lining material to and through said hole.

2. The form of claim 1, wherein said leading side of said leading part has an attachment for an elongated pulling element.

3. The form of claim 2, wherein said attachment for said elongated pulling element comprises said attachment for a supply tube employed as said pulling element.

4. The form of claim 1, wherein said leading part has a concave trailing surface and said trailing part has a convex leading surface, said surfaces being separated by a gap forming said channel in the body.

5. The form of claim 4, wherein said at least one peripheral opening is formed by a periphery of said gap.

6. The form of claim 4, wherein said concave trailing surface and said convex leading surface are both frusto-conical.

7. The form of claim 1, wherein said leading part and said trailing part are joined by one or more rigid struts.

8. The form of claim 1, wherein said leading part has a flexible edge region adjacent a radially outer periphery thereof.

9. The form of claim 1, wherein said trailing part has a skirt extending rearwardly from a leading surface of the part.

10. The form of claim 9, wherein said skirt has a region adjacent to said leading surface that slopes away from a central axis of the form in the rearward direction followed by a region that slopes towards said central axis in the rearward direction.

11. The form of claim 1, wherein said trailing part has a hollow interior and houses apparatus for modifying lining material.

12. The form of claim 11, wherein the apparatus for modifying lining material is selected from the group consisting of a manifold for delivering a liquid to a plurality of holes extending from said hollow interior to an exterior of the trailing part, a vibrator for compacting lining material, and a heater for heating lining material.

13. The form of claim 1, comprising guides extending from said trailing part positioned to cause said form to be centered within a pipe having an inner diameter corresponding to said diameter of said leading part.

14. A form for lining an interior of a pipe, comprising:
a material feeder part and a material applicator part axially aligned and joined together with a gap there-between;
the material feeder part having an outer periphery, a front wall extending to said outer periphery, an opening in the front wall communicating with said gap, and a rear wall adjacent said gap extending from said opening to said outer periphery of the material feeder part;
the material applicator part comprising a body having a leading wall terminating at a peripheral edge and a peripheral skirt extending axially of said body rearwardly from the peripheral edge of said leading wall, said leading wall sloping rearwardly and outwardly from a central region to said peripheral edge;
wherein said periphery of said material feeder part extends by a greater radial distance than said peripheral edge and peripheral skirt of said material applicator part.

15. The form of claim 14, wherein said outer periphery of said material feeder part is formed by a flexible resilient radially outer element attached to a rigid radially inner element.

16. The form of claim 14, wherein said leading wall of the material applicator part is conically convex and has an angle relative to a central axis of the form in a range of 5 to 90°.

17. The form of claim 14, wherein said leading wall of the material applicator part is conically convex and has an angle relative to a central axis of the form in a range of 30 to 60°.

18. The form of claim 14, wherein said peripheral skirt has a first circumferential region and a second circumferential region, with the first region extending axially rearwardly from said peripheral edge, and the second circumferential region extending rearwardly from the first circumferential region, said first circumferential region sloping radially outwardly in a rearward direction.

19. The form of claim 18, wherein said first circumferential region has an outward angle relative to a central axis of the form in a range of 0 to 80°.

20. The form of claim 18, wherein said first circumferential region has an outward angle relative to a central axis of the form in a range of 0 to 15°.

21. The form of claim 18, wherein said second circumferential region slopes radially inwardly in said rearward direction.

22. The form of claim 21, wherein said second circumferential region slopes radially inwardly in said rearward direction at an relative to a central axis of the form angle in a range of 0 to 10°.

23. The form of claim 21, wherein said second circumferential region slopes radially inwardly in said rearward direction at an relative to a central axis of the form angle in a range of 0 to 5°.

24. The form of claim 14, wherein said rear wall of the material feeder part is conically concave.

25. The form of claim 24 wherein the leading wall of said material applicator part is conically convex with said leading wall being nested within said rear wall on opposite sides of said gap.

26. The form of claim 14, wherein said material feeder part and said material applicator part are joined together by one or more struts extending between said parts within or adjacent to said gap.

27. The form of claim 26, having three such struts.

28. The form of any claim 14, comprising at least one rigid guide extending radially outwardly from said material applicator part and terminating at a radial distance substantially the same as that of the outer periphery of the material feeder part.

29. The form of claim 14 including a tube attached to said front wall of the material applicator part, said tube having an interior channel communicating with said opening.

30. The form of claim 29, wherein said tube has tensile strength effective to allow said tube, in use, to pull said form through a pipe while feeding a flowable settable compound thereto through said tube.

31. A method forming a lining in a pipe, comprising:
supplying a flowable settable lining material to a leading end of a lining form for the pipe through a tube passing through said pipe,
and pulling the form through the pipe as said lining material is supplied thereto;
said form being chosen to have a structure such that the lining material supplied from the pipe is directed by the form to an exterior surface of the form adjacent to, but spaced from, an interior surface of the pipe.

32. The method of claim 31, wherein the form is a pipe lining for as defined in claim 1.

33. The method of claim 31, wherein the form is a pipe lining for as defined in claim 14.

34. The method of claim 31, wherein the form is pulled through the pipe by exerting a pulling force on said tube.

35. The method of claim 31, wherein a liquid curing agent is introduced into said lining material from said form as said material is directed to said exterior surface of the form.

36. The method of claim 31, wherein the lining material is vibrated by said form.

37. The method of claim 31, wherein the lining material is heated by said form.
